(19) United States
(12) Patent Application Publication
(10) Pub. No.: US 2008/0222122 A1
(43) Pub. Date: Sep. 11, 2008

(54) INFORMATION SEARCH APPARATUS, INFORMATION SEARCH METHOD THEREOF, AND RECORDING MEDIUM

(75) Inventor: Daisuke Morita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/041,261

(22) Filed: Mar. 3, 2008

(30) Foreign Application Priority Data
Mar. 6, 2007 (JP) 2007-56176

(51) Int. Cl. G06F 7/06; G06F 17/30

(52) U.S. Cl. 707/4; 707/E17.017

(57) ABSTRACT

An information search apparatus for searching an internal information resource within an apparatus and an external information resource connected via a network includes a search unit searching the internal information resource and the external information resource at the same time or in series based on an inputted search condition, and an information output unit outputting a search result.

### CROSS-REFERENCE TO RELATED APPLICATIONS

This application is based upon and claims the benefit of priority from the prior Japanese Patent Application No. 2007-56176 filed on Mar. 6, 2007, the entire contents of which are incorporated herein by reference.

### BACKGROUND OF THE INVENTION

1. Field of the Invention

The present invention relates to an information search function provided by software which is installed in a computer such as a personal computer and to an information search function provided by an open server on the internet.

2. Description of the Related Art

A search engine for searching for information stored in a storage device of a computer and a search engine for searching a database using a URL (Uniform Resource Locator) are known as information search functions. The information search function searches the database for the information obtained from web pages which are open on the internet. A keyword search using search terms, a category search following a hierarchical classification and the like are known as an information search method.

With respect to the above described information search, Japanese Patent Application Laid-Open Publication No. 2005-190065 discloses that the information is collected from a network such as a web. The information viewed by the user is stored with indexes of record information, such as an information position and a viewing time for identification. If there is a citation correlation between a viewing order of the information and the viewed information, a structure of the citation correlation is stored as well as the citation correlation which is actually used.

With respect to the information search, Google Desktop (http://desktop.google.com/en/) is known. Google Desktop displays a Google search screen in a computer to collect contents which are open on the web or the contents stored in the computer, Google Desktop uses search items or keywords and signs of the search items inputted in a search box of the screen as search keys. Then the display displays the information indicating the item and the like on the screen.

### SUMMARY OF THE INVENTION

According to an aspect of an embodiment, an information search apparatus for searching an internal information resource within an apparatus and an external information resource connected via a network includes:

a search unit searching the internal information resource and the external information resource at the same time or in series based on an inputted search condition; and

an information output unit outputting a search result.

The above-described embodiments of the present invention are intended as examples, and all embodiments of the present invention are not limited to including the features described above.

### BRIEF DESCRIPTION OF THE DRAWINGS

FIG. 1 is a diagram illustrating an information search system according to a first embodiment;

FIG. 2 is a diagram illustrating a configuration example of the information search system;

FIG. 3 is a diagram illustrating a configuration example of an information search apparatus;

FIG. 4 is a diagram illustrating an external view of the information search apparatus;

FIG. 5 is a diagram illustrating a configuration example of an internet server;

FIG. 6 is a flow chart illustrating an example of a process of an information search method of the information search system and an information search program;

FIG. 7 is a diagram illustrating an example of a search screen;

FIG. 8 is a diagram illustrating an example of a setting screen;

FIG. 9 is a flow chart illustrating an example of the process for confirming and setting a search condition;

FIG. 10 is a flow chart illustrating an example of the process for setting the search condition;

FIG. 11 is a flow chart illustrating an example of the process of a search;

FIG. 12 is a flow chart illustrating a processing sequence of the search;

FIG. 13 is a diagram illustrating an example of a display screen of a local search result;

FIG. 14 is a diagram illustrating an example of the display screen of a web search result;

FIG. 15 is a diagram illustrating an example of the display screen of an integrated search result;

FIG. 16 is a flow chart illustrating the process of a network connection;

FIG. 17 is a diagram illustrating an example of a search screen;

FIG. 18 is a flow chart illustrating an example of the processing sequence of the search according to a second embodiment;

FIG. 19 is a diagram illustrating a configuration example of the information search system according to a third embodiment;

FIG. 20 is a diagram illustrating a configuration example of the information search system according to other embodiment; and

FIG. 21 is a diagram illustrating a configuration example of the information search system according to other embodiment.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

### First Embodiment

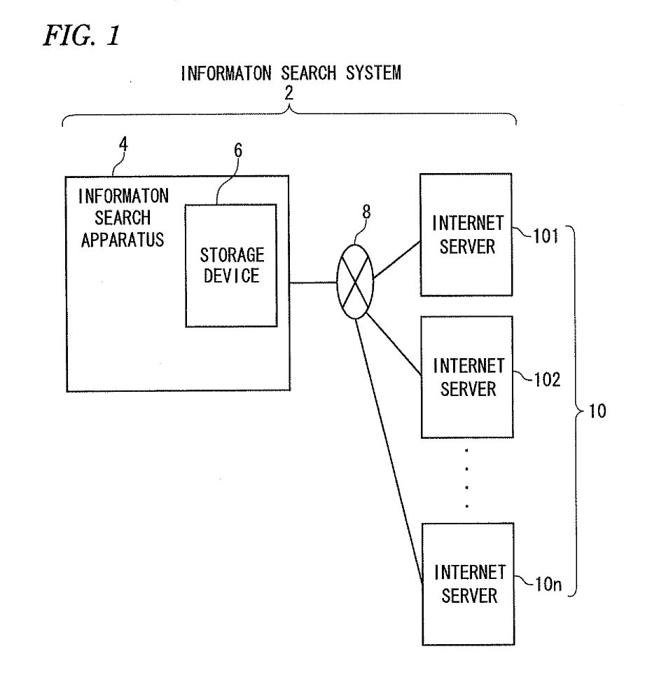

A first embodiment will now be described, with reference to FIG. 1. FIG. 1 is a diagram illustrating an example of an information search system according to the first embodiment.

An information search system 2 includes an information search apparatus 4 capable of searching both an internal information resource and an external information resource of the apparatus. The information search apparatus 4 is provided with a storage device 6 as the internal information resource within the apparatus. The storage device 6 can be either singular or plural.

The information search apparatus 4 is connected to a single or a plurality of internet servers 10 as the external information resource, e.g., internet servers 101, 102, . . . 10n, via a network 8. The network 8 can be a single network, or can be cooperated with a plurality of the networks. The information search apparatus 4 executes an information search either on the storage device 6 or the internet servers 101, 102, . . . 10n according to a search condition. The information search apparatus 4 may also execute the information search both on the storage device 6 and the internet servers 101, 102, . . . 10n in a cross-sectorial manner. In this case, the internet servers 101, 102, . . . 10n can be the information search apparatus 4 having the storage device 6 as the information resource which provides information.

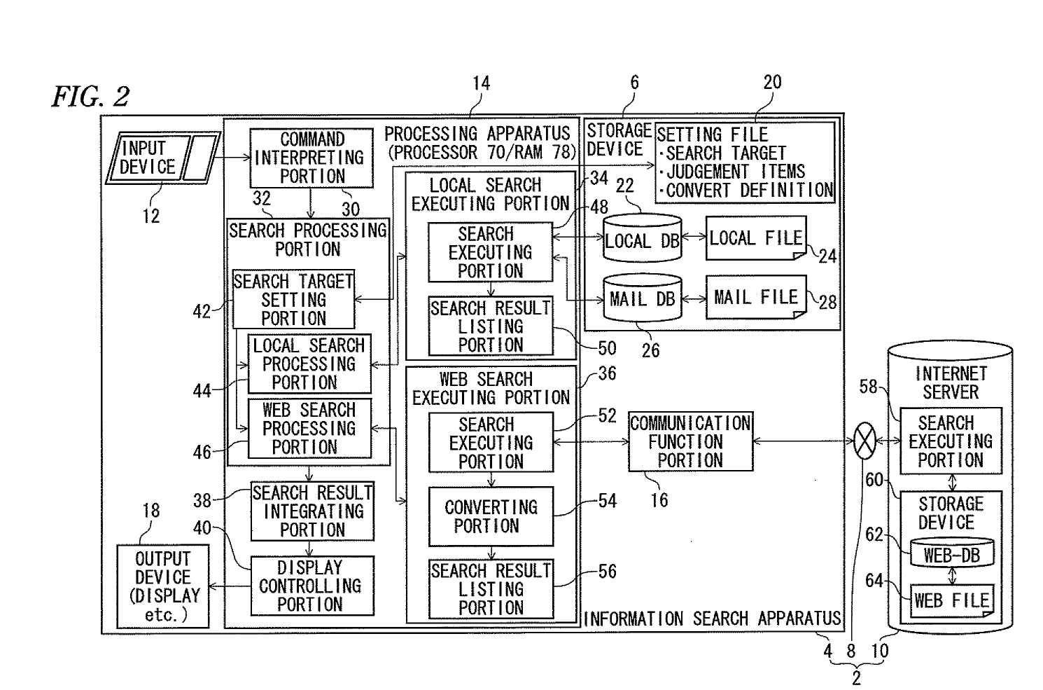

A configuration example of the information search system 2 will be described, with reference to FIG. 2. FIG. 2 is a diagram illustrating a configuration example of the information search system. In FIG. 2, the parts that are the same as those in FIG. 1 are given the same reference numerals.

In the information search system 2 shown in FIG. 2, the internet server with a numeral 10 is shown as an example of the internet servers 101, 102, . . . 10n shown in FIG. 1.

The information search apparatus 4 is a computer capable of processing the information search and includes a storage device 6, an input device 12, a processing apparatus 14, a communication function portion 16, and an output device 18. The storage device 6 is the internal information resource provided within the information search apparatus 4 and includes a setting file 20, a local database (a local DB) 22, a local file 24, an e-mail database (an e-mail DB) 26, an e-mail file 28 and the like.

The setting file 20 stores setting information such as a search target, a decision item of a degree of coincidence, and a conversion definition. The search target is information indicating a search item or a search information resource. The decision item of the degree of coincidence is information indicating an item for deciding the degree of coincidence between the search condition and the search result. The conversion definition is information indicating a definition for converting the search result of the internal information resource and the search result of the external information resource into an identical decision target. The local DB 22 and the local file 24 store various information such as documents other than e-mails. The e-mail DB 26 and the e-mail file 28 store e-mails. The e-mail can contain images such as photos and the like.

The input device 12, e.g., a keyboard and the like, is an input portion for inputting various commands such as search conditions and information selections in a dialog display screen presented in the output device 18.

The processing apparatus 14 is a search portion for executing a searching process based on the inputted search condition. The processing apparatus 14 may search the above described internal information resource and the external information resource at the same time or in series. The processing apparatus 14 is comprised of a processor 70 (FIG. 2) for executing a program, or a RAM (Random-Access Memory) 78 (FIG. 2). In this embodiment, by executing the program by the processor 70, the processing apparatus 14 includes a command interpreting portion 30, a search processing portion 32, a local search executing portion 34, a web (World Wide Web) search executing portion 36, a search result integrating portion 38, and a display controlling portion 40 as processing functions.

The command interpreting portion 30 is a functional portion for interpreting commands inputted from the input device 12. For example, the command interpreting portion 30 interprets the inputted search condition and provides an interpretation result to the search processing portion 32.

The search processing portion 32 starts the searching processing according to the search target, the decision item of the degree of coincidence and the conversion definition stored in the storage device 6 in response to the interpretation result of the search condition. The search processing portion 32 is a functional portion for giving the search result to the search result integrating portion 38. The search processing portion 32 includes a search target setting portion 42, a local search processing portion 44, and a web search processing portion 46.

The search target setting portion 42 selects the search target, the decision item of the degree of coincidence and the conversion definition stored in the storage device 6 and sets these components to the local search processing portion 44 and the web search processing portion 46.

For local search processing portion 44 directs the web search executing portion 36 to execute a web search based on the setting made by the search target setting portion 42, and receives the search result from the web search executing portion 36.

The local search executing portion 34 is an executive functional portion for executing the search of the local DB 22 and the e-mail DB 26 of the storage device 6. The local search executing portion 34 includes a search executing portion 48 and a search result listing portion 50.

The search executing portion 48 executes the search on the local DB 22 and the e-mail DB 26. The search result listing portion 50 executes a listing process of the search result which is obtained from the local DB 22 and the e-mail DB 26 by the search of the search executing portion 48.

The web search executing portion 36 is an executive functional portion for executing the searching process of information. The web search executing portion 36 also executes a conversion process according to the degree of coincidence and the listing process of the search result on a side of the internet server 10. The web search executing portion 36 includes a search execution portion 52, a degree of coincidence converting portion 54, and a search result listing portion 56. The search execution portion 52 executes the search on the information of the side of the internet server 10.

The degree of coincidence converting portion 54 executes the conversion process on the search result obtained by the search execution portion 52 according to the degree of coincidence between the search condition and the search result.

The search result listing portion 56 executes the listing process of the search result and provides the process result to the web search processing portion 46.

The search result integrating portion 38 receives a local search result and a web search result from the search processing portion 32 to execute integrating process of both search results. This is the integrating process for ranking the search results in accordance with the degree of coincidence between the search condition and the search result without distinguishing between the local search result and the web search result. The ranking is process of ranking the information items which are the search results in accordance with the degree of coincidence.

A display controlling portion 40 is a function portion for controlling the outputting the search result to the output device 18 and also is a generating portion for generating messages. The display controlling portion 40 provides the search result to the output device 18. If the output device 18 is a display, the display controlling portion 40 controls a screen display of the display screen.

A communication function portion 16 is the function portion which is in charge of communication with the external information resource. In this embodiment, the information is transmitted and received in communication with the internet server 10 via the network 8. The communication does not have to be a wired communication. A wireless communication using a communication medium such as electric wave is applicable.

The output device 18 is an example of an information output portion for outputting the search result of the processing apparatus 14 and is a display such as a LCD (Liquid Crystal Display). The web search executing portion 36 displays the output information which is outputted to be viewable by the display controlling portion 40. This output device 18 displays a dialog box and is used as the input portion of the information. The output device 18 can be a device for outputting an audio output and can also be a printer

The internet server 10 is an example of the external information source capable of searching the information by a search direction of the information search apparatus 4. The internet server 10 includes a search executing portion 58 and a storage device 60.

The search executing portion 58 is connected in communication to the communication function portion 16 of the information search apparatus 4 via the network 8. The search executing portion 58 receives the search condition and the like from a search executing portion 52, executes the search of the information stored in the storage device 60, and provides the search result to the web search executing portion 36.

The storage device 60 includes a web database (WEB-DB) 62 and a web file 64 to store various information.

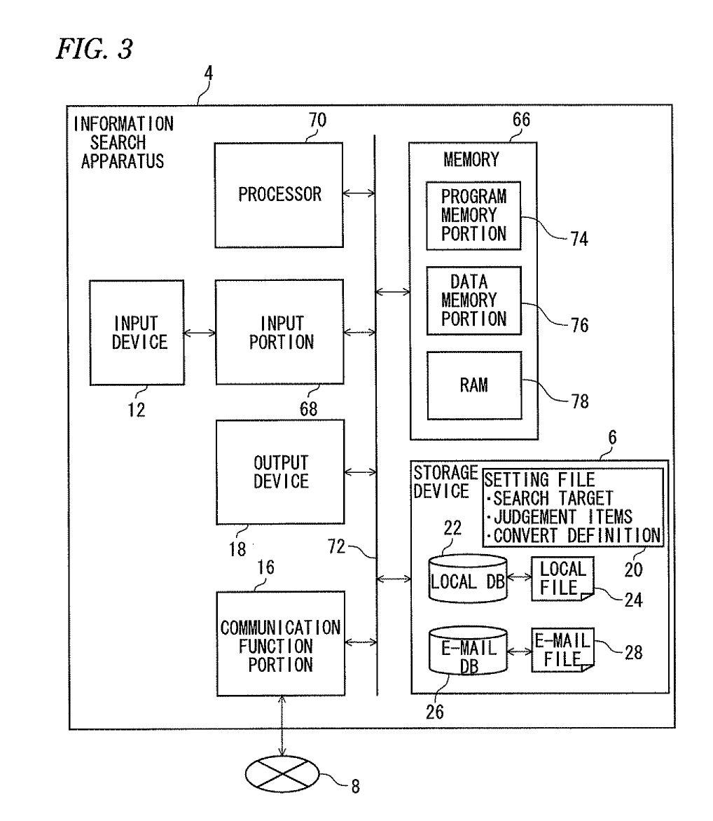

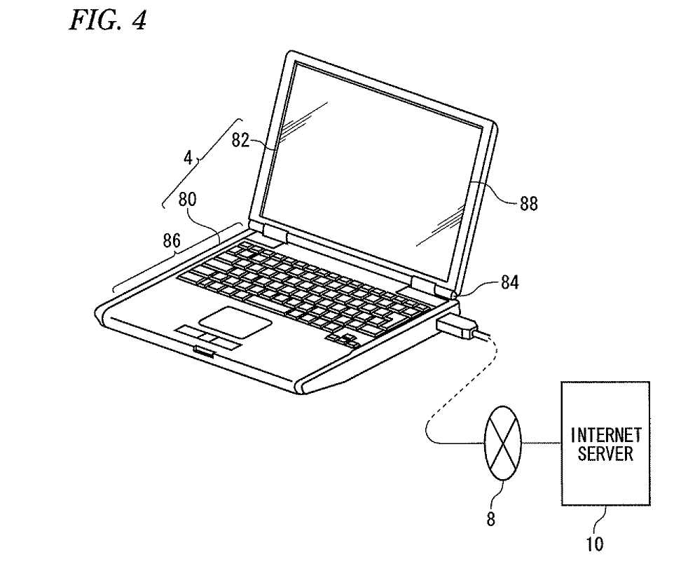

Next, hardware of the information search apparatus 4 will be described, with reference to FIG. 3 and FIG. 4. FIG. 3 is a diagram illustrating an example of the information search apparatus. FIG. 4 is a diagram illustrating an external view of the information search apparatus. In FIG. 3 and FIG. 4, the parts that are the same as those in FIG. 2 are given the same reference numerals.

As already described, the information search apparatus 4 is a computer having an information search function and a communication function. The information search apparatus 4 includes a storage device 6, a communication function portion 16, an input device 12, an output device 18, a memory 66, an input portion 68, and a processor 70 and these components are connected by a bus 72.

The memory 66 is a computer-readable recording medium having a program memory portion 74, a data memory portion 76, and a RAM 78.

The program memory portion 74 stores an OS (Operating System) which is a basic program, an information search program which is an application program, a screen display program and the like.

The data memory portion 76 stores various information such as the search result.

The RAM 78 comprises a work area. Based on the execution of the program, the above described processing apparatus 14 (FIG. 2) is configured by the RAM 78 and the processor 70 in the information search apparatus 4.

The processor 70 is a central processing portion which is, e.g., a CPU (Central Processing Unit) or a MPU (Micro Processing Unit). Other configurations are given the same reference numerals as FIG. 2 and the descriptions of the other configuration are omitted.

As shown in FIG. 4, the information search apparatus 4 is, e.g., a foldable computer having a first housing 80 coupled with a second housing 82 by a hinge 84. The first housing 80 has built-in hardware (FIG. 3) excluding a display which is the output device 18 and has a keyboard 86 which is the input device 12 on the surface thereof. The second housing 82 includes a display portion 88 which is the output device 18. If a printer is used as the output device 18, the printer is connected to a USB connecter or a network connecter provided in the first housing 80.

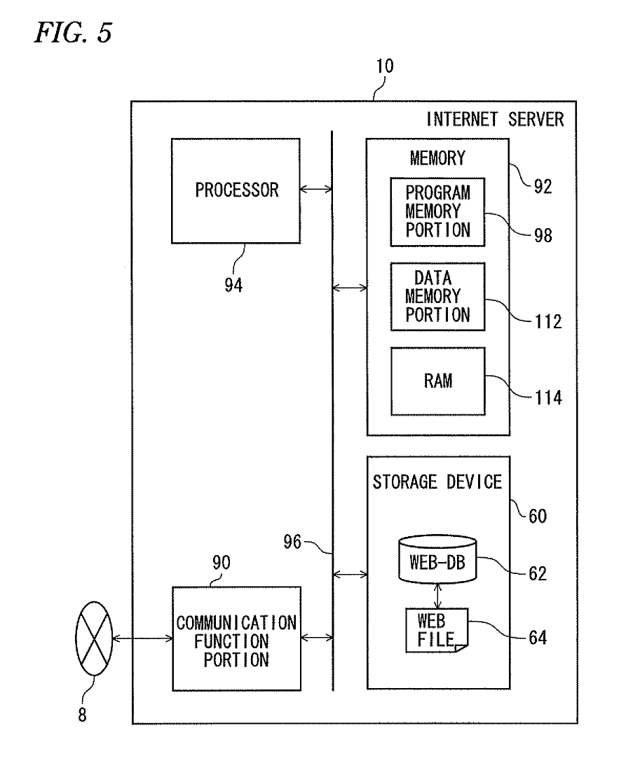

Next, hardware of the internet server 10 will be described, with reference to FIG. 5. FIG. 5 is a diagram illustrating a configuration example of the internet server. In FIG. 5, the parts that are the same as those in FIG. 2 are given the same reference numerals.

The Internet server 10 is a computer having an information search function and a communication function. The internet server 10 includes a storage device 60, a communication function portion 90, a memory 92, and a processor 94 and these components are connected by a bus 96.

The memory 92 is a recording medium for storing information which is to be computer-readable and includes a program memory portion 98, a data memory portion 112, and a RAM 114.

The program memory portion 98 stores an OS which is a basic program, the information search program which is an application program, the screen display program and the like.

The data memory portion 112 stores various information such as the search result.

The RAM 114 comprises a work area. Based on the execution of the program, the above described search executing portion 58 (FIG. 2) is configured by the RAM 114 and the processor 94 in the internet server 10.

The processor 94 is a central processing portion which is, e.g., a CPU or a MPU. Other configurations are given the same reference numerals as FIG. 2 and the descriptions thereof are omitted.

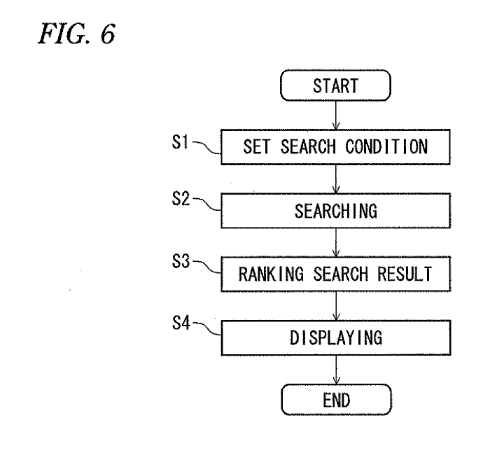

A process of this information search system will be described, with reference to FIG. 6. FIG. 6 is a flow chart illustrating an example of an information search method of the information search system and the process of the information search program.

This process includes each process of setting the search condition, searching of the information, ranking the search results, and displaying the search results.

By executing the information search program, an inquiry is made to a user whether or not to set the search condition. The dialog box is expanded in a setting screen of the search condition, i.e., a screen display of the output device 18, in response to a confirmation or a direction of setting the search condition given by the user in order to set the search condition specified by the user (operation S1). In this case, setting process of the search condition includes maintaining the current setting and confirming the setting.

After the setting of the search condition, the process goes to the searching process. The search is executed in this searching process by using a search keyword inputted by the user according to the setting of the search condition (operation S2). This information search is executed on the internet server 10 and the storage device 6 at the same time or in series.

The search results obtained by the searching process are ranked in accordance with the degree of coincidence between the search condition and the search result (operation S3). The ranked search results are displayed in a display screen of a display portion 88 (FIG. 4) of the output device 18 (operation S4).

It is possible to search the information of the storage device 6 and the internet server 10 in this searching process in a cross-sectorial manner without distinguishing between the internal information resource and the external information resource. The search results are integrated and ranked for display in accordance with the degree of coincidence.

The user can increase the search target by setting the search condition and can obtain the search results which are ranked according to the degree of coincidence of the search condition in order to utilize the search results. Furthermore, it is possible to improve the efficiency and the speed of the search because there is no need to transit the search to the internet server 10 after the search of the storage device 6.

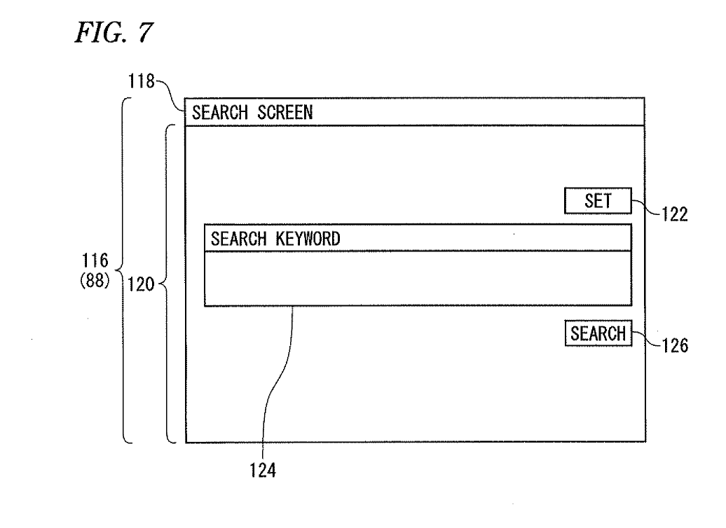

Next, a search screen will be described, with reference to FIG. 7. FIG. 7 is a diagram illustrating an example of the search screen. In FIG. 7, the parts that are the same as those in FIG. 4 are given the same reference numerals

The search screen 116 is an example of the dialog box for communication between the information search apparatus 4 and the user, and is displayed in the display portion 88 of the output device 18. A title display portion 118 and an input display portion 120 are displayed in the search screen 116. The title display portion 118 displays “search screen” as a title display indicating a type of the screen. A set button 122, a keyword input box 124, and a search button 126 are displayed in the input display portion 120. The set button 122 is an input button for proceeding to the setting of the search condition. If the set button 122 is clicked with the cursor, the input is determined and the display goes to the setting screen. The keyword input box 124 is an entry box for inputting the search keyword. The search button 126 is the input portion for starting searching for the search keyword inputted in the keyword input box 124. If the search button 126 is clicked with the cursor, the input is determined and the process goes to the searching process.

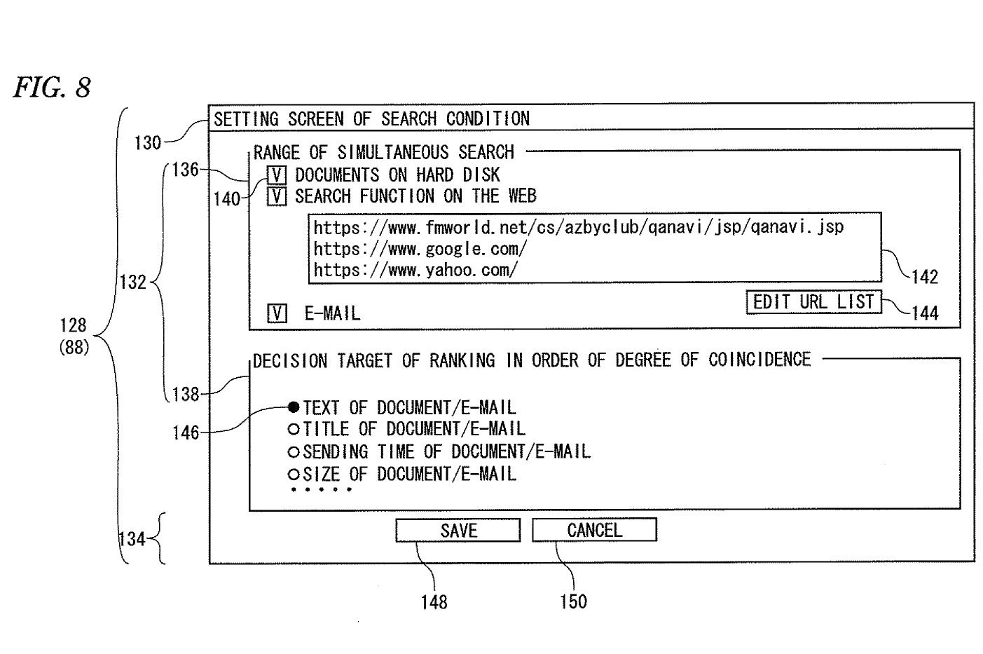

Next, the setting screen of the search condition will be described, with reference to FIG. 8. FIG. 8 is a diagram illustrating an example of the setting screen of the search condition. In FIG. 8, the parts that are the same as those in FIG. 4 are given the same reference numerals.

The setting screen 128 of the search condition is an example of the dialog box for interaction between the information search apparatus 4 and the user. The setting screen 128 is expanded in the display portion 88 of the output device 18. A title display portion 130, a setting information display portion 132, and a select portion 134 are displayed in the setting screen 128. The title display portion 130 displays “setting screen of search condition” as a title display indicating a type of the screen. The setting information display portion 132 is provided with a search area display portion 136 specifying a “range of simultaneous searching” and a judgment condition display portion 138 specifying a “decision target of ranking in order of the degree of coincidence”. The display portion 136 displays the following, as a title indicating the search range, a selectable document, a search function, an e-mail and the like, which are selectable by inputting checks in a dialog box 140:

(a) documents on hard disk;

(b) search function on the web; and

(c) e-mail

The “documents on hard disk” is document information stored in the local DB 22 or in the local file 24 of the storage device 6.

The “search function on the web” specifies a search site for executing the searching process, and the URL of the target search site is displayed in a display area 142. The user can add or delete a URL of the target search site. An edit instruction button 144 labeled as “edit URL list” is displayed under the display area 142 of the “search function on the web” to indicate editing process of the URL list. The user can edit the URL list of the search site by clicking the edit instruction button 14.

The “e-mail” is e-mail document information stored in the e-mail DB 26 or in the e-mail file 28 of the storage device 6.

A judgment condition display portion 138 displays the following, as a title indicating the decision target of ranking by the degree of coincidence and the criterion of the degree of coincidence, which are selectable in a dialog box 146:

(d) text of document/e-mail;

(e) title of document/e-mail;

(f) sending time of document/e-mail; and

(g) size of document/e-mail

A setting instruction button 148 labeled as “save” is displayed in the select portion 134 to indicate the storing of the setting the condition, and a cancel instruction button 150 labeled as “cancel” is displayed to indicate the cancelling of the setting.

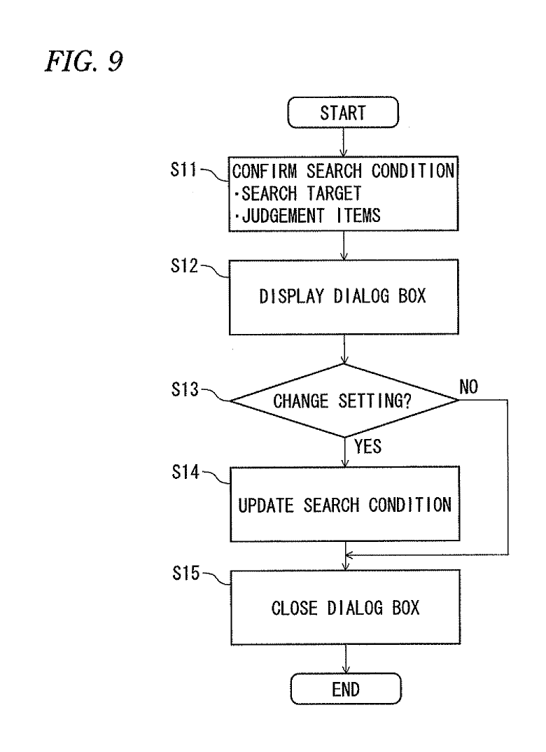

Next, the confirming and/or the setting of the search condition will be described, with reference to FIG. 9. FIG. 9 is a flow chart illustrating an example of the process for confirming and setting the search condition.

By clicking the set button 122 of the search screen 116 (FIG. 7), the screen goes to a setting screen 128 (FIG. 8) of the search condition. Thus, it is possible to confirm the search target which is currently set and the search condition such as the degree of coincidence by using the setting screen 128 (operation S11). At this time, the setting screen is displayed as the dialog box (operation S12). The current search condition is confirmed in accordance with the display content of the setting screen 128 in order to input a new setting or to change the setting content.

At the end of this setting screen, it is determined whether or not the setting is changed (operation S13). If the setting is changed (Yes in operation S13), the search condition is updated (operation S14), and the dialog box (the setting screen 128 of the search condition: FIG. 8) is closed to end this process. On the other hand, if the setting is not changed (No in operation S13), the dialog box is closed (operation S15) to end this process.

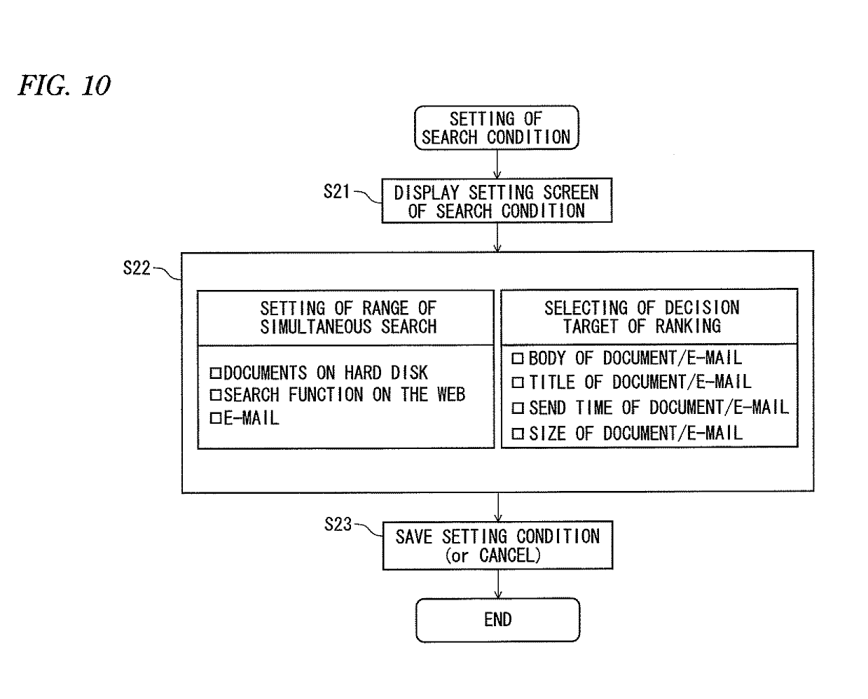

Next, the setting the setting screen of the search condition will be described, with reference to FIG. 10. FIG. 10 is a flow chart illustrating an example of the process for setting the search condition by the setting screen of the search condition.

In the process for setting the search condition, the setting screen 128 (FIG. 8) is displayed in the display portion 88 of the output device 18 (operation S21). A desired item is selected from the dialog box of the setting area of the range of simultaneous search and from the selecting area of the decision target of ranking in order of the degree of coincidence, displayed in the setting screen 128 (operation S22). The selected setting condition is stored (or cancelled) (operation S23). Then this process ends.

Using the above described setting screen to input the search condition or to change the search condition or the like makes it easy to set the search condition.

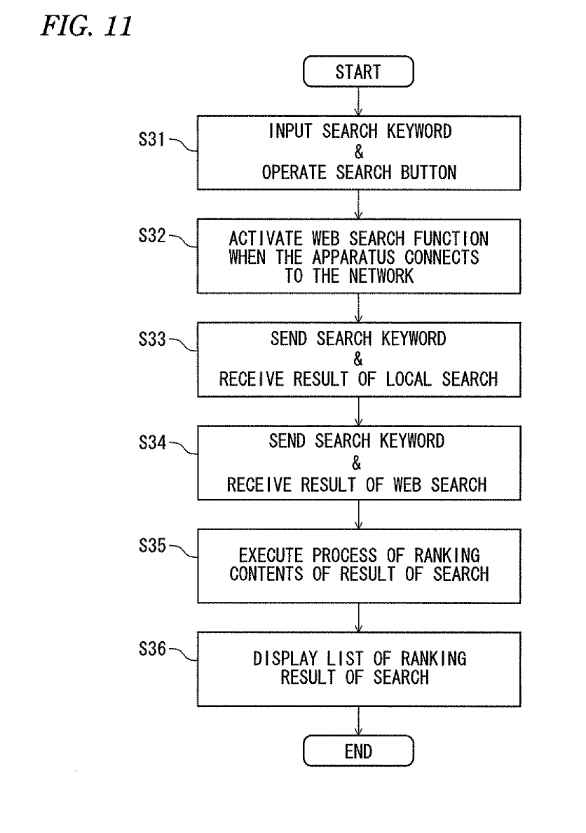

Next, the process of the information search will be described, with reference to FIG. 11. FIG. 11 is a flow chart illustrating an example of the process of the information search using the search screen.

The search keyword is inputted in the search screen 116 (FIG. 7), and the search button 126 is operated (operation S31). This makes the local search possible. It is determined whether or not the information search apparatus 4 is connected to the network 8. If the information search apparatus 4 is connected to the network 8, a web search function becomes available (operation S32).

In the local search, the search keyword is provided to a local search executing portion 34. Accordingly, the local search is executed and the search result is received from the storage device 6 (operation S33).

In the web search, the search keyword is provided to a web search executing portion 36. This makes the internet server 10 execute the web search, and the search result is received from the internet server 10 (operation S34).

Ranking process is executed based on the degree of coincidence added to the content of the local search result and the web search result (operation S35). This process also includes the integrating process of each search result.

Then, a list display output of the ranked search results is provided to the output device 18 for display. This display includes the local search result, the web search result or the search result of the integrating process.

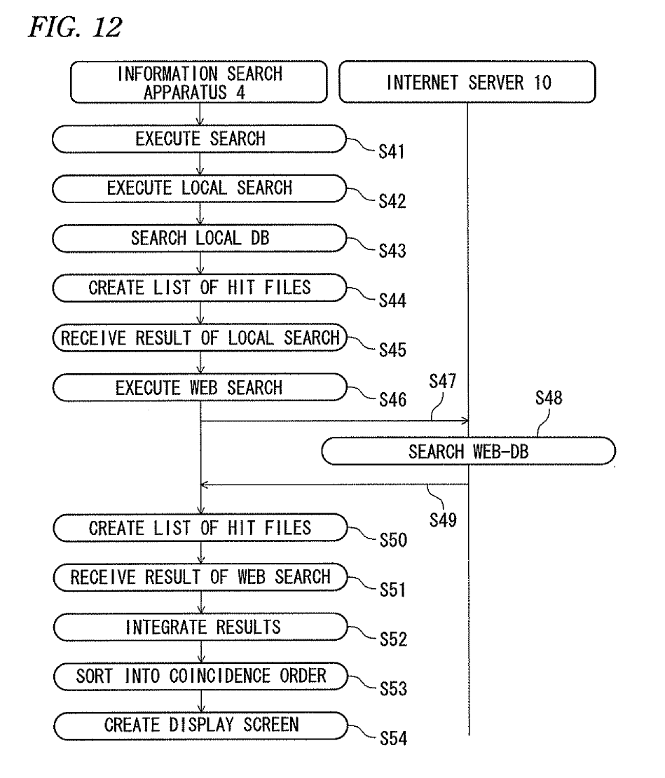

Next, a processing sequence of searching in a cross-sectorial manner on a plurality of information sources will be described, with reference to FIG. 12. FIG. 12 is a flow chart illustrating an example of the processing sequence of the searching the content of the storage device and the internet server.

In this embodiment, the storage device 6 is provided as the internal information resource of the information search apparatus 4, and the internet server 10 is provided as the external information resource of the information search apparatus 4. In the present processing sequence, the searching process of the storage device 6 corresponds to internal processing, and the searching process of the internet server 10 corresponds to external processing. Thus, executing process on a side of the information search apparatus 4 corresponds to the executing process on the side of the internet server 10. In this processing sequence, the internet server 10 includes a single or a plurality of internet servers 101, 102, . . . 10n.

First, the search is executed when the search keyword is inputted in the keyword input box 124 (FIG. 7) and the search button 126 is clicked (operation S41). In this example, the local search comes before the web search. Thus, the local search is executed on internal contents (operation S42). The search is executed on a local DB 22 and an e-mail DB 26 of the storage device 6 in accordance with the search condition (FIG. 8) (operation S43). A list of files hit by this search is made (operation S44), and the local search result is received (operation S45).

Following the local search, the process goes to executing of the web search (operation S46), and an execution direction of the search is indicated to the internet server 10 (operation S47). When the internet server 10 receives the direction, the web search is executed on external contents. The search is executed in a search executing portion 58 on the web DB 62 and the web file 64 of the storage device 60 (operation S48). The search result is transferred to the information search apparatus 4 (operation S49).

The list of the hit files is made in the information search apparatus 4 based on the search result transferred from the internet server 10 (operation S50), and the web search result is received (operation S51) by the information search apparatus 4. Then the local search result and the web search result are integrated (operation S52). The integrated results are ranked in order of the degree of coincidence (operation S53). A display screen of a display portion 88 is generated (operation S54), and the search results ranked according to the degree of coincidence are displayed with the rank order. The local search result, the web search result, and the integrated search result can be displayed as this search result, respectively.

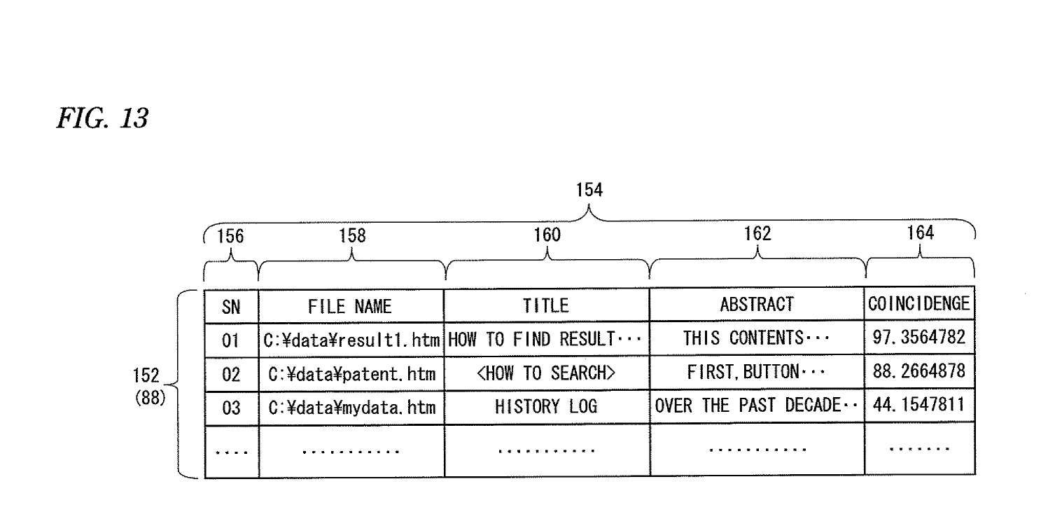

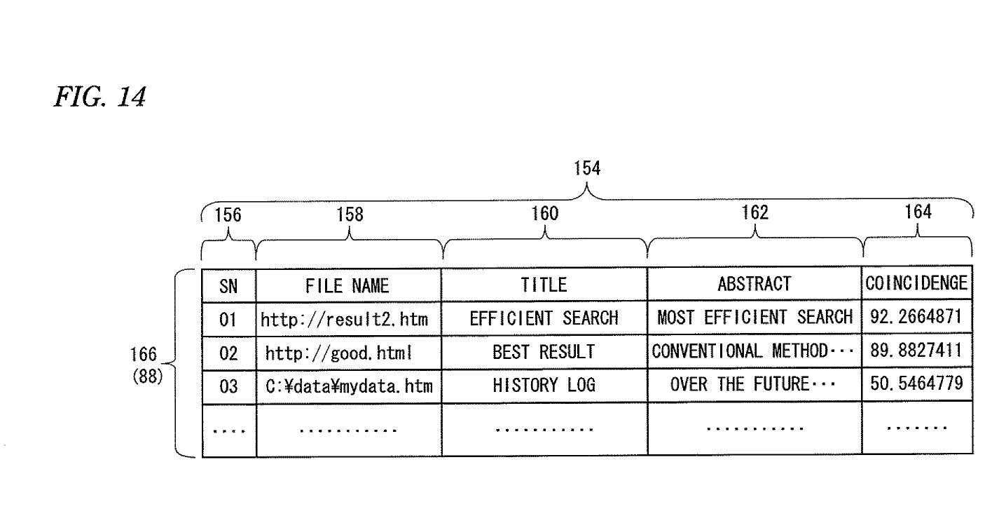

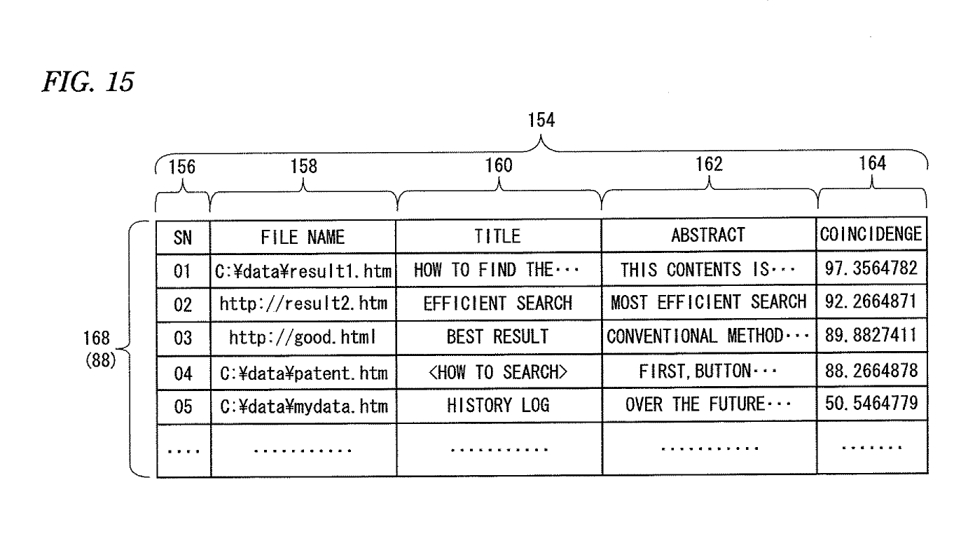

Next, a display example of the search result will be described, with reference to FIG. 13, FIG. 14, and FIG. 15. FIG. 13 is a diagram illustrating an example of the display screen of the local search result. FIG. 14 is a diagram illustrating an example of the display screen of the web search result. FIG. 15 is a diagram illustrating an example of the display screen of the integrated search result of the local search result and the web search result. In FIG. 13 and FIG. 14, the parts that are the same as those in FIG. 4 are given the same reference numerals.

As shown in FIG. 13, a display screen 152 is displayed in the local search result. This display screen 152 is an example of the list display of the local search result. A serial number display portion 156, a file name display portion 158, a title display portion 160, an abstract display portion 162, and a degree of coincidence display portion 164 are formed in a display area 154.

The serial number display portion 156 displays the rank order numbers according to the degree of coincidence. The file name display portion 158 displays the file name indicating the search result. The title display portion 160 displays the information of the title. The abstract display portion 162 displays parts of the words or the documents, for example, parts of the opening words specifying the search result information. The degree of coincidence display portion 164 displays a value of the percentage representing the degree of coincidence.

As shown in FIG. 14, a display screen 166 is displayed in the web search result. The display screen 166 is an example of the list display of the web search result. The display area 154 is formed and displayed as well as in the local search result.

As shown in FIG. 15, a display screen 168 is displayed in the integrated search result. The display screen 168 is an example of the list display of the integrated search result. The display area 154 is formed as well as in the local search result, and is displayed as well as in the local search result and the web search result. The content of the display screen 168 displays the integrated result of both search results. The degree of coincidence is integrated to be evaluated in a cross-sectorial manner without distinguishing between the local search result and the web search result. Thus, the integrated search results are ranked in accordance with the degree of coincidence. The serial number represents the number of the rank order of the integrated result of both search results. A smaller number represents a higher rank order.

As described above, in the present embodiment, the information search can be executed without distinguishing between the storage device 6 of hard disk or the like of the computer comprising the information search apparatus 4 and the external internet server 10. Therefore, the present embodiment receives the search result as the local search result and the web search result, and executes the integrating process of these results. Then the integrated search results are ranked in accordance with the degree of coincidence and are displayed in the list. This makes it possible to improve the efficiency and the speed of the search and to increase the availability of the search result.

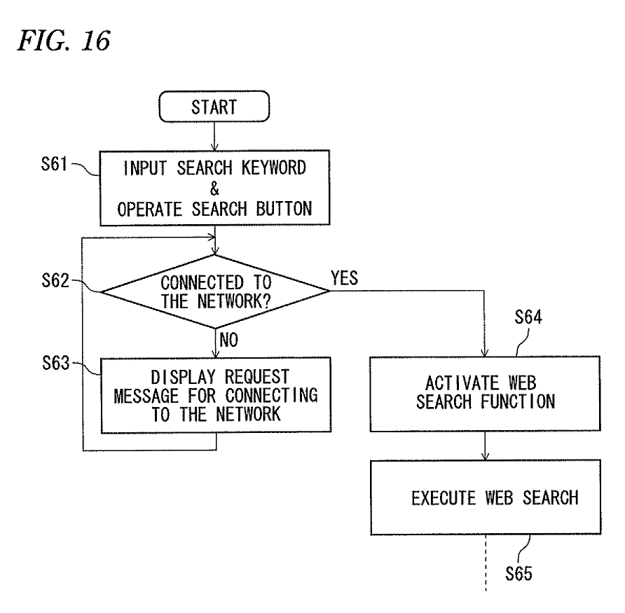

In the process shown in FIG. 11, the process is executed to enable the web search in case of being connected to the network. However, the web search function also can be achieved through the process shown in FIG. 16, for example.

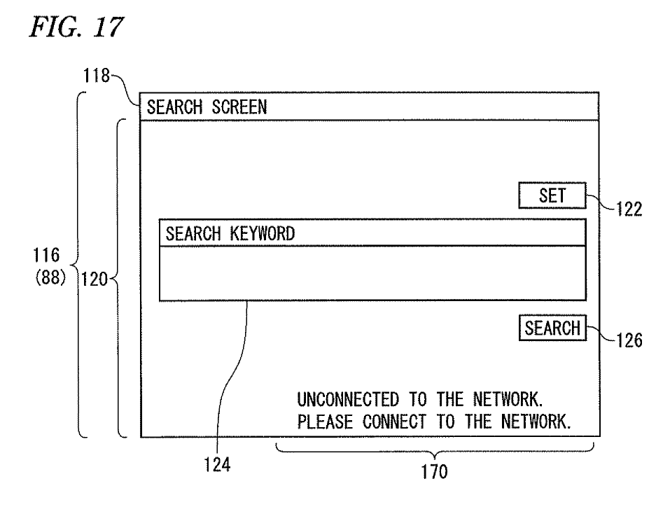

In this process, first, the keyword is inputted and the search button 126 is operated (operation S61). Then it is determined whether or not the information search apparatus 4 is connected to the network (operation 362). As a result of the determination, if the information search apparatus 4 is not connected to the network (No in operation 362), e.g., as shown in FIG. 17, a request message 170 for connection is displayed in a search screen 116 as the request message for connection to the network (operation S63) in order to request for the connection. If the user connects the information search apparatus 4 to the network or if the information search apparatus 4 is already connected to the network (Yes in operation S62), the web search function becomes available (operation S64), and the web search is executed (operation S65).

In this process, if the user does not need to execute the web search, the user can change the setting to execute only the local search by going to the setting screen 128 of the search condition (FIG. 8) and removing checks from the dialog box 140.

### Second Embodiment

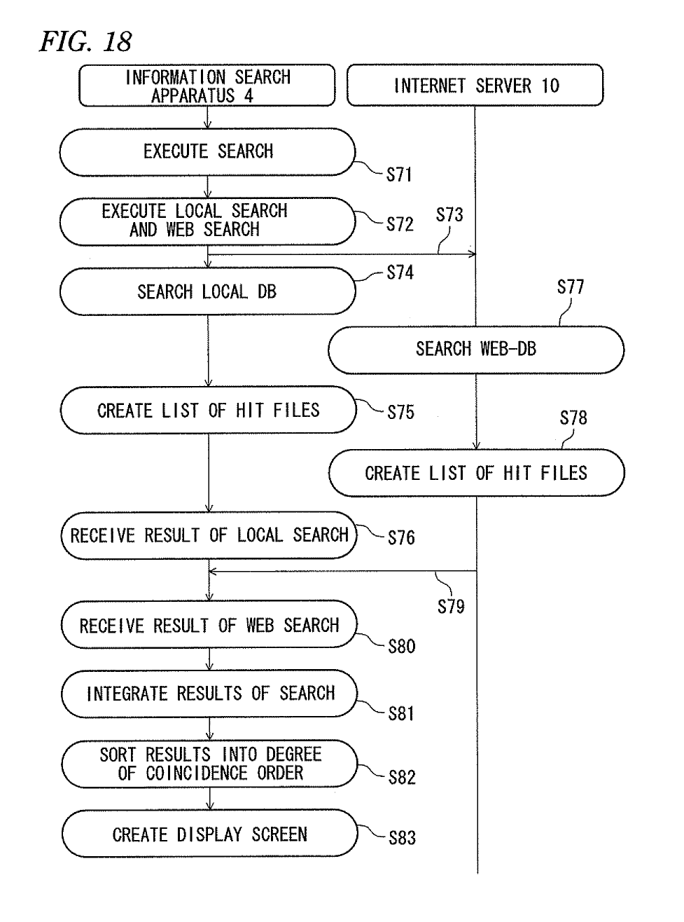

Next, a second embodiment will be described, with reference to FIG. 18. FIG. 18 is a flow chart illustrating an example of the processing sequence of the searching process according to the second embodiment.

The first embodiment, as shown in FIG. 12, executes the web search after executing the local search. However, as shown in FIG. 18, the second embodiment executes the local search and the web search at the same time.

The information search system 2 of FIG. 1 and FIG. 2 is used also in the second embodiment. The internet server 10 includes a single or a plurality of the internet servers 101, 102, . . . 10n.

If the user inputs the keyword in the keyword box 124 (FIG. 7) and clicks the search button 126, the searching process is executed (operation S71). With this execution direction, the local search and the web search are executed at the same time (operation S72). Then the information search apparatus 4 transmits the execution direction of the web search to the internet server 10 (operation S73). The information search apparatus 4 receives the execution direction of the local search and searches the local DB 22 and the e-mail DB 26 of the storage device 6 according to the setting of the search condition (operation S74). As a result of the search, the list of the hit files is formed (operation S75) and the result of the local search is received (operation S76).

At the same time of executing the local search, when receiving the execution direction of the web search, the internet server 10 executes the web search to search a WEB-DB 62 and a web file 64 of the storage device 60 in a search executing portion 58 (operation S77). The internet server 10 forms the list of the files hit by the search (operation S78) and transfers the search result to the information search apparatus 4 (operation S79).

The information search apparatus 4 receives the web search result from the internet server 10 (operation S80), integrates the result of the local search and the result of the web search (operation S81), ranks the search results according to the degree of coincidence (operation S82), generates the display screen of the display portion 88 (operation S83), and displays the search results ranked according to the degree of coincidence together with the rank order. As the display of this search result, the display of the local search result and/or the web search result can be omitted, resulting in only the integrated search result.

### Third Embodiment

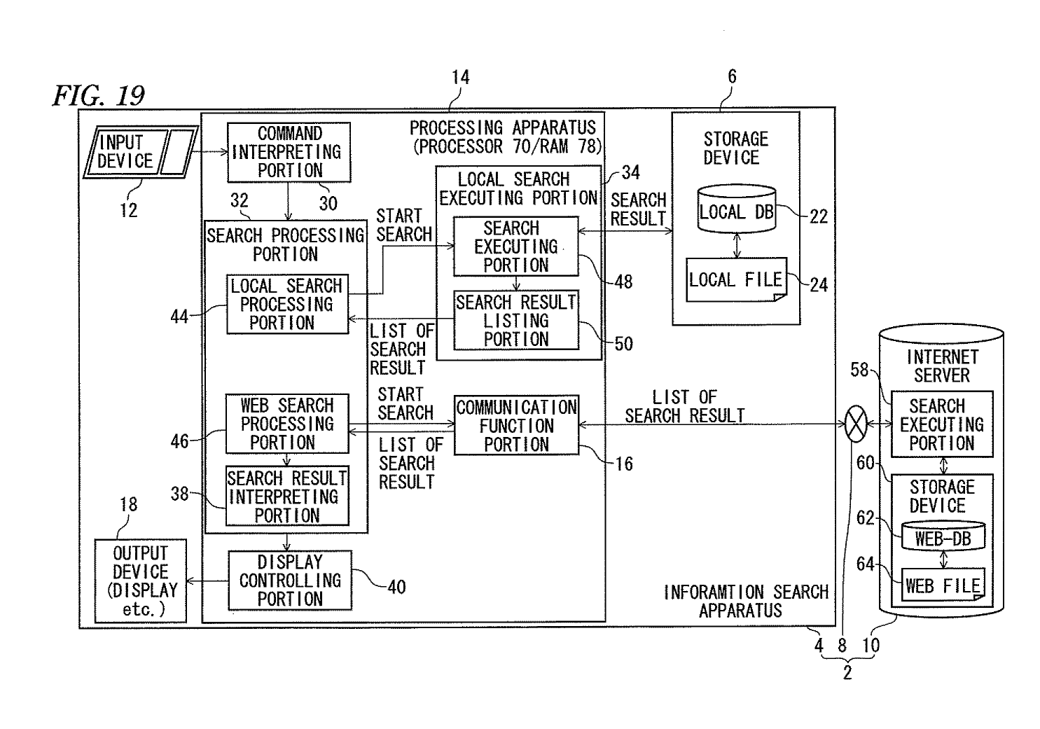

Next, a third embodiment will be described, with reference to FIG. 19. FIG. 19 is a diagram illustrating an example of the information processing system according to the third embodiment. In FIG. 19, the parts that are the same as those in FIG. 2 are given the same reference numerals.

In the information search system 2 of the present embodiment, a communication function portion 16, a command interpreting portion 30, a search processing portion 32, a local search executing portion 34, and a display controlling portion 40 are configured in a processing apparatus 14. The search processing portion 32 is configured by a local search processing portion 44, a web search processing portion 46, and a search result integrating portion 38.

In the present embodiment, the local search processing portion 44 and the web search processing portion 46 start the searching process according to the search direction provided from the search processing portion 32. The local search processing portion 44 directs the search executing portion 48 to start the search. The web search processing portion 46 transmits a search start direction to the internet server 10 through the communication function portion 16.

The search start direction is transmitted from the local search processing portion 44 to the search executing portion 48 of the local search executing portion 34, and the local search processing portion 44 receives the list of the search result from a search result listing portion 50. The search executing portion 48 executes the searching process of the storage device 6 and receives the search result from the storage device 6. In the present embodiment, although the e-mail DB 26 and the e-mail file 28 (FIG. 2) shown in FIG. 2 of the storage device 6 are not provided, the e-mail DB 26 and the e-mail file 28 can be provided as well as in the first embodiment.

According to the search direction, the web search processing portion 46 makes the communication function portion 16 transmit information of the starting the search. This makes the internet server 10 to start the information search. The list of the search result which is the search result of the storage device 60 obtained by the search executing portion 58 is received by the web search processing portion 46 through the communication function portion 16 and is provided to the search result integrating portion 38. The search result integrating portion 38 executes the integrating process of the local search result obtained by the local search processing portion 44 and the web search result obtained by the web search processing portion 46. In the present embodiment, the ranking according to the degree of coincidence at the time of the integrating process, the making of the list and the displaying process are the same as those in the first embodiment.

### Other Embodiments

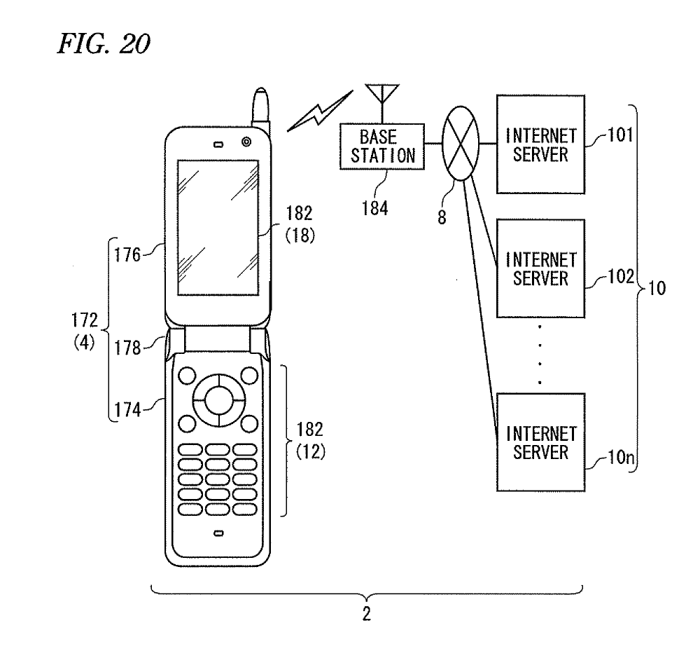

(1) In the information search system 2 of the above described embodiment, a personal computer is used as the information search apparatus 4. However, as shown in FIG. 20, a mobile terminal 172 having a communication function such as a mobile phone and the like can be used as the information search apparatus 4. FIG. 20 is a diagram illustrating the information search system 2 using the mobile terminal 172.

The mobile terminal 172 is a foldable device having a first housing 174 coupled with a second housing 176 by a hinge 178. The housing 174 has a keyboard 180 as the input device 12. The second housing 176 has a display portion 182 as the output device 18. The display portion 182 is, e.g., a LCD.

The mobile terminal 172 has the storage device 6 described above as the internal information resource. The mobile terminal 172 uses the connection of wireless communication to the base station 184 connected to the network 8 in order to be connected to the internet server 10 which is the external information resource. Other configurations according to the present embodiment are the same as those of the first embodiment, so that the descriptions thereof are omitted.

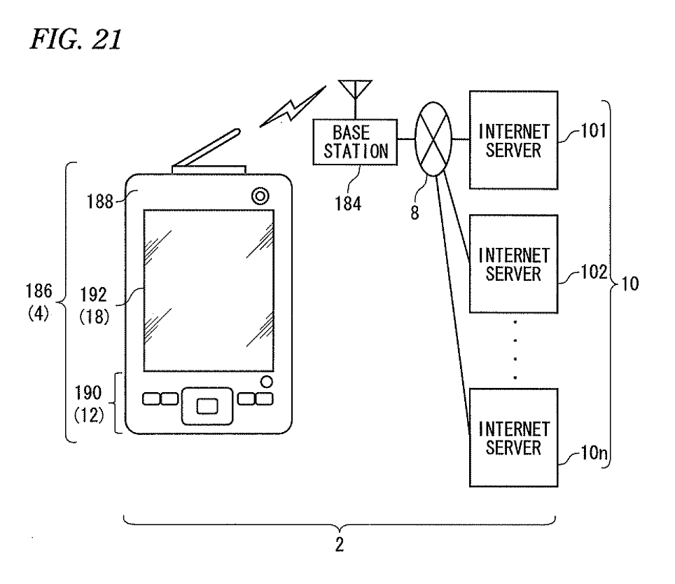

(2) The information search system 2 can use, e.g., a Personal Digital Assistant (PDA) as shown in FIG. 21. FIG. 21 is a diagram illustrating the information search system 2 using the PDA 186 as the information search apparatus 4.

The PDA 186 has a key input portion 190 in the housing 188 as the input device 12 and the display portion 192 as the output device 18. The display portion 192 is composed of, e.g., a LCD. The PDA 186 has the above described storage device 6 as the internal information resource. The PDA 186 uses the connection of wireless communication to the base station 184 connected to the network 8 in order to be connected to the internet server 10 which is the external information resource. Other configurations according to the present embodiment are the same as those of the first embodiment, so that the descriptions thereof are omitted.

(3) In the above described embodiment, if the internet server 10 (101, 102, . . . 10n) is configured in the information search apparatus 4, the information search function and the information utilization can be improved on the side of the internet server 10.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An information search apparatus for searching an internal information resource within an apparatus and an external information resource connected via a network, the apparatus comprising:
a search unit searching the internal information resource and the external information resource at the same time or in series based on an inputted search condition; and
an information output unit outputting a search result.

2. The information search apparatus according to claim 1 wherein the search unit ranks the search result according to a degree of coincidence between information of the information resource and the search condition, the information output unit outputs the search result that is ranked.

3. The information search apparatus according to claim 2, wherein the search unit integrates the search result of the internal information resource and the search result of the external information resource and ranks the search result that is integrated.

4. The information search apparatus according to claim 3, wherein the information output unit outputs either or both of the search result in which the internal information resource and the external information resource search are integrated to be ranked and the search result in which the search results are ranked individually.

5. The information search apparatus according to claim 1, wherein the search unit adds at least one of identification information for identifying information in the resources, an information content, and a degree of coincidence between information in the resources and the search condition to the search result.

6. The information search apparatus according to claim 1, further comprising a generate unit generating message indicative of disconnection from the network or a request for connecting to the network in cases where the information search apparatus is not connected to the network when the search unit searches the external information resource.

7. The information search apparatus according to claim 1, wherein the internal information resource is a storage device put in a computer to store information.

8. The information search apparatus according to claim 1, wherein the external information resource is a server connected via the network or a storage device connected to the server.

9. An information search method for searching an internal information resource within an apparatus and an external information resource connected via the network, the method comprising:
searching the internal information resource and the external information resource at the same time or in series based on a search condition that is inputted; and
outputting the search result.

10. The information search method according to claim 9, further comprising:
ranking the search result according to the degree of coincidence between information in the resources and the search condition, and
outputting the search result that is ranked.

11. The information search method according to claim 10, further comprising:
integrating the search result of the internal information resource and the search result of the external information resource, and
ranking the integrated search result.

12. The information search method according to claim 11, further comprising:
outputting either or both of the search results in which the search result of the internal information resource and the search result of the external information resource are integrated to be ranked and the search result in which the search results are ranked individually.

13. The information search method according to claim 9, further comprising:
adding at least one of identification information for identifying information in the resources, an information content and a degree of coincidence between information in the resources, and the search condition to the search result.

14. The information search method according to claim 9, further comprising:
generating a message indicative of disconnection from the network or a request for connecting to the network in cases where the apparatus executing the information search method is not connected to the network when the searching searches the external information resource.

15. A computer-readable storage medium including a program for causing a computer to execute operations, the program comprising:
searching an internal information resource within the computer and an external information resource to which the computer is connected via the network at the same time or in series based on a search condition that is inputted; and
outputting the search result.

16. The computer-readable storage medium according to claim 15, the program further comprising:
ranking the search result according to a degree of coincidence between information in the resources and the search condition, and
outputting the search result that is ranked.

17. The computer-readable storage medium according to claim 16, the program further comprising:
integrating the search result of the internal information resource and the search result of the external information resource,
ranking the integrated search result.

18. The computer-readable storage medium according to claim 17, the program further comprising:
outputting either or both of the search results in which the search result of the internal information resource and the search result of the external information resource are integrated to be ranked or the search result in which the search results are ranked individually.

19. The computer-readable storage medium according to claim 15, the program further comprising:
adding at least one of identification information for identifying information in the resources, an information content, and a degree of coincidence between information in the resources and the search condition to the search result.

20. The computer-readable storage medium according to claim 15, the program further comprising:
generating a message indicative of disconnection to the network or a request for connecting to the network in cases the apparatus executing the information search method is not connected to the network when the searching searches the external information resource.
